(19) United States
(12) Patent Application Publication
(10) Pub. No.: US 2025/0193317 A1
(43) Pub. Date: Jun. 12, 2025

(54) Call Notification Apparatus and Method

(71) Applicant: Detach Tech Limited, London (GB)

(72) Inventor: Eliza Twist, London (GB)

(21) Appl. No.: 18/764,703

(22) Filed: Jul. 5, 2024

(30) Foreign Application Priority Data
Dec. 8, 2023 (GB) 2318779.2

(51) Int. Cl. H04M 19/04; H04M 1/663; H04M 3/42

(52) U.S. Cl. CPC H04M 19/045; H04M 1/663; H04M 3/42034

(57) ABSTRACT

Apparatuses, methods, computer programs and systems for notifying calls, for example voice calls, to a user in such a manner as to avoid disturbing the user when they are asleep. For example, there is disclosed a system including a user terminal and a notification device. The user terminal may be configured to enable selection of one or more preferential contacts, to receive a call request, to transmit to the notification device a notification of the call request if the call request is from a preferential contact and to refrain from transmitting to the notification device a notification of the call request if the call request is from a number or contact which is other than a preferential contact.

### CROSS-REFERENCE TO RELATED APPLICATION

This application claims priority to British Application No. GB2318779.2, filed on Dec. 8, 2023, the content of which is incorporated herein by reference in its entirety.

### FIELD

Various example embodiments relate to apparatuses, methods, computer programs and systems for notifying calls, for example voice calls, to a user in such a manner as to avoid disturbing the user when they are asleep.

### BACKGROUND

Sleep hygiene, which generally refers to the environment and behaviours that may affect a person's ability to sleep, are of increasing interest. Good quality sleep, in particular duration of continuous sleep, is important for a user's physical and mental health. It is common, however, for people to keep user terminals, such as mobile telephones, in the same room where they sleep and often by the bedside. This means that call and message notifications may disturb people whilst they are asleep. People may also be inclined to use other functions of the user terminal after being disturbed by notifications, which may delay or prevent them returning to sleep. People may keep their user terminal in the same room where they sleep because they feel the need to be available for certain important calls.

### SUMMARY

The scope of protection sought is set out by the independent claims.

According to a first aspect, there is described a user terminal, comprising: means for identifying one or more preferential contacts; means for receiving a call request; means for transmitting, to a remote notification device which is linked to the user terminal, a notification of the call request if the call request is associated with a preferential contact; and means for refraining to transmit to the notification device at least a notification of the call request if the call request is associated with a telephone number or contact which is other than a preferential contact.

In some example embodiments, the one or more preferential contacts may be identified by receiving a selection of the one or more preferential contacts from a contact list associated with a calling application of the user terminal, and the user terminal may be configured to access the contact list, display on a display device a first user interface showing at least some of the one or more contacts of the contact list, and receive selection of the one or more preferential contacts by means of one or more user inputs made via the display device.

In some example embodiments, the display device may be a display screen of the user terminal.

In some example embodiments, the display device may be a display screen of the notification device, and wherein the selection may be received by means of one or more data messages received from the notification device.

In some example embodiments, identification of at least some of the one or more preferential contacts may be performed automatically based on a label or property associated with the one or more contacts of the contact list.

In some example embodiments, the label or property may indicate that: the contact is an emergency contact; and/or the contact has made and/or received more than a threshold number of calls with the user terminal within a predetermined recent time period.

In some example embodiments, the user terminal may comprise further means for refraining to transmit to the remote device other notifications associated with non-calling applications which are being run on the user terminal.

In some example embodiments, the user terminal may further comprise: means for receiving from the notification device a call acceptance signal indicating that a user accepts a call request from a preferential contact that has been notified to the notification device; means for responsively accepting the call request from a network from which the call request was received; and means for forwarding subsequent voice data received from the network to the notification device and voice data received from the notification device to the network.

In some example embodiments, at least the means for identifying the one or more preferential contacts, and the means for transmitting and refraining to transmit the notification of the call request may be provided as part of a dedicated application for being executed on the user terminal.

In some example embodiments, the dedicated application may operate such that said means are enabled without requiring enablement of a do-not-disturb mode or night-time mode provided by the user terminal.

In some example embodiments, the user terminal may further comprise: means for determining that the apparatus is within a predetermined range of the notification device; and means for responsively signaling to the notification device that the user terminal is within the predetermined range.

In some example embodiments, the user terminal may comprise a mobile terminal such as a mobile telephone.

According to a second aspect, there is described a notification device, comprising: means for receiving a notification of a call request, wherein the call request is associated with a preferential contact; and means for accepting or rejecting the notified call request.

The notification of the call request may be received from a user terminal which is linked to the notification device. The link may for example be a Bluetooth, WiFi or Zigbee link.

The notification of the call request may alternatively be received from a remote user terminal of a preferential contact by means of a calling application of the remote user terminal pre-associated with a call receiving application of a user terminal linked to the notification device and/or a calling receiving application of the notification device.

According to some example embodiments, the notification device may further comprise: means for, in response to receiving acceptance of the notified call request, transmitting a call acceptance signal to the user terminal for causing the user terminal to accept the call request from a network.

According to some example embodiments, the notification device may further comprise: means for receiving voice data which has been forwarded from the network by the user terminal for being output by one or more loudspeakers; and means for transmitting voice data received by one or more microphones to the user terminal for being forwarded to the network.

According to some example embodiments, the notification device may be configured such that the call request notification is made, at least in part, by emitting audio sounds from one or more loudspeakers of the notification device.

According to some example embodiments, the notification device may further comprise: a display screen, wherein the notification device is configured such that the call request notification is displayed by the display screen.

According to some example embodiments, the display screen may comprises a touch-sensitive touch screen, and wherein the display screen may be configured to display respective first and second selectable graphical elements which are responsive to touch inputs for accepting or rejecting the call request.

According to some example embodiments, the notification device may further comprise: means for displaying a clock.

According to some example embodiments, the notification device may further comprise: means for providing an alarm for causing at least an alert tone to be emitted by one or more loudspeakers of the notification device at a predetermined time.

According to some example embodiments, the display screen may be operated such as to emit low or no blue light during use.

According to some example embodiments, the notification device may further comprise: means for outputting colored noise in response to a user input.

According to some example embodiments, the notification device may further comprise: means for receiving signaling from the user terminal indicative that the user terminal is within a predetermined range of the notification device; and means for responsively indicating via a visual and/or audible alert that the user terminal is within the predetermined range of the notification device.

According to some example embodiments, the notification device may further comprise: means for determining that the notification device is within a predetermined range of the user terminal; and means for responsively indicating via a visual and/or audible alert that the user terminal is within the predetermined range of the notification device.

According to a third aspect, there is described a notification device, comprising: means for providing a list of one or more preferential contacts of a contact list; means for receiving a call request; means for outputting a notification of the call request if the call request is associated with a preferential contact; and means for refraining to output a notification of the call request if the call request is not associated with a preferential contact.

According to a fourth aspect, there is described a method, comprising: identifying one or more preferential contacts; receiving a call request; transmitting, to a remote notification device, a notification of the call request if the call request is associated with a preferential contact; and refraining to transmit to the notification device at least a notification of the call request if the call request is associated with a telephone number or contact which is other than a preferential contact.

In some example embodiments, the one or more preferential contacts may be identified by receiving a selection of the one or more preferential contacts from a contact list associated with a calling application, wherein the method may further comprise accessing the contact list, displaying on a display device a first user interface showing at least some of the one or more contacts of the contact list, and receiving selection of the one or more preferential contacts by means of one or more user inputs made via the display device.

In some example embodiments, the display device may be a display screen of a user terminal.

In some example embodiments, the display device may be a display screen of the notification device, and wherein the selection may be received by means of one or more data messages received from the notification device.

In some example embodiments, identification of at least some of the one or more preferential contacts may be performed automatically based on a label or property associated with the one or more contacts of the contact list.

In some example embodiments, the label or property may indicate that: the contact is an emergency contact; and/or the contact has made and/or received more than a threshold number of calls within a predetermined recent time period.

In some example embodiments, the method may further comprise refraining to transmit to the remote device other notifications associated with non-calling applications of a user terminal.

In some example embodiments, the method may further comprise: receiving from the notification device a call acceptance signal indicating that a user accepts a call request from a preferential contact that has been notified to the notification device; accepting the call request from a network from which the call request was received; and forwarding subsequent voice data received from the network to the notification device and voice data received from the notification device to the network.

In some example embodiments, identifying the one or more preferential contacts, and transmitting and refraining to transmit the notification of the call request may be provided as part of a dedicated application for being executed on a user terminal.

In some example embodiments, the dedicated application may operate such that said identifying, transmitting and refraining are performed without requiring enablement of a do-not-disturb mode or night-time mode provided by a user terminal.

In some example embodiments, the method may further comprise: determining that a user terminal is within a predetermined range of the notification device; and responsively signaling to the notification device that the user terminal is within the predetermined range.

In some example embodiments, the method may be performed by a user terminal which may comprise a mobile terminal, such as a mobile telephone.

According to a fifth aspect, there is described a method, comprising: receiving, from a user terminal, a notification of a call request wherein the call request is associated with a preferential contact; and accepting or rejecting the notified call request.

The notification of the call request may be received from a user terminal which is linked to the notification device. The link may for example be a Bluetooth, WiFi or Zigbee link.

The notification of the call request may alternatively be received from a remote user terminal of a preferential contact by means of a calling application of the remote user terminal pre-associated with a call receiving application of a user terminal or of a notification device to which the call request may be notified.

According to some example embodiments, the method may further comprise: in response to receiving acceptance of the notified call request, transmitting a call acceptance signal to the user terminal for causing the user terminal to accept the call request from a network.

According to some example embodiments, the method may further comprise: receiving voice data which has been forwarded from the network by the user terminal for being output by one or more loudspeakers; and transmitting voice data received by one or more microphones to the user terminal for being forwarded to the network.

According to some example embodiments, the method may comprise performing the call request notification by, at least in part, emitting audio sounds from one or more loudspeakers of a notification device.

According to some example embodiments, the method may further comprise: displaying the call request notification by a display screen of the notification device.

According to some example embodiments, the display screen may comprise a touch-sensitive touch screen, and wherein the method may further comprise displaying respective first and second selectable graphical elements which are responsive to touch inputs for accepting or rejecting the call request.

According to some example embodiments, the method may further comprise displaying a clock.

According to some example embodiments, the method may further comprise: providing an alarm for causing at least an alert tone to be emitted by one or more loudspeakers of a notification device at a predetermined time.

According to some example embodiments, the display screen may be operated such as to emit low or no blue light during use.

According to some example embodiments, the method may further comprise outputting colored noise in response to a user input.

According to some example embodiments, the method may further comprise: receiving signaling from the user terminal indicative that the user terminal is within a predetermined range of a notification device; and responsively indicating via a visual and/or audible alert that the user terminal is within the predetermined range of the notification device.

According to some example embodiments, the method may further comprise: determining that a notification device is within a predetermined range of the user terminal; and responsively indicating via a visual and/or audible alert that the user terminal is within the predetermined range of the notification device.

According to a sixth aspect, there is described a method, comprising: providing a list of one or more preferential contacts of a contact list; receiving a call request; outputting a notification of the call request if the call request is associated with a preferential contact; and refraining to output a notification of the call request if the call request is not associated with a preferential contact.

According to a seventh aspect, there is described a computer program product, comprising a set of instructions which, when executed on an apparatus, is configured to cause the apparatus to carry out a method of any one of the fourth to sixth aspects.

According to an eighth aspect, there is described a non-transitory computer readable medium comprising program instructions stored thereon to cause an apparatus to carry out a method of any one of the fourth to sixth aspects.

According to a ninth aspect, there is described an apparatus comprising at least one processing core, at least one memory including computer program code, the at least one memory and the computer program code being configured to, with the at least one processing core, cause the apparatus to carry out a method of any one of the fourth to sixth aspects.

### DRAWINGS

Various example embodiments will be described, by way of non-limiting example, with reference to the accompanying drawings, in which:

FIG. 1 is a schematic view of a system according to some example embodiments;

FIG. 2 is a screen shot of a user interface of a user terminal of the FIG. 1 system, according to some example embodiments;

FIG. 3 is a flow diagram showing operations according to some example embodiments;

FIG. 4 is a perspective view of a notification device of the FIG. 1 system, according to some example embodiments;

FIG. 5A is a perspective view of a notification device of the FIG. 1 system, upon receiving a call notification, according to some example embodiments;

FIG. 5B is a perspective view of a further notification device of the FIG. 1 system, upon receiving a call notification, according to some example embodiments;

FIG. 6 is a flow diagram showing operations according to some example embodiments; and

FIG. 7 is a schematic view of an apparatus, which may comprise the user terminal or notification device, according to some example embodiments;

### DETAILED DESCRIPTION

Various example embodiments will now be described, and may relate to apparatuses, methods, computer programs and systems for notifying calls, for example voice calls, in such a manner as to avoid disturbing the user when they are asleep.

As discussed above, it is common for some users of user terminals to keep their user terminal in the same room where they sleep, often by the bedside. This means that call and message notifications may cause a disturbance. Some users may keep their user terminal in the same room where they sleep because they feel the need to be available for receiving important calls.

Example embodiments may help alleviate such issues.

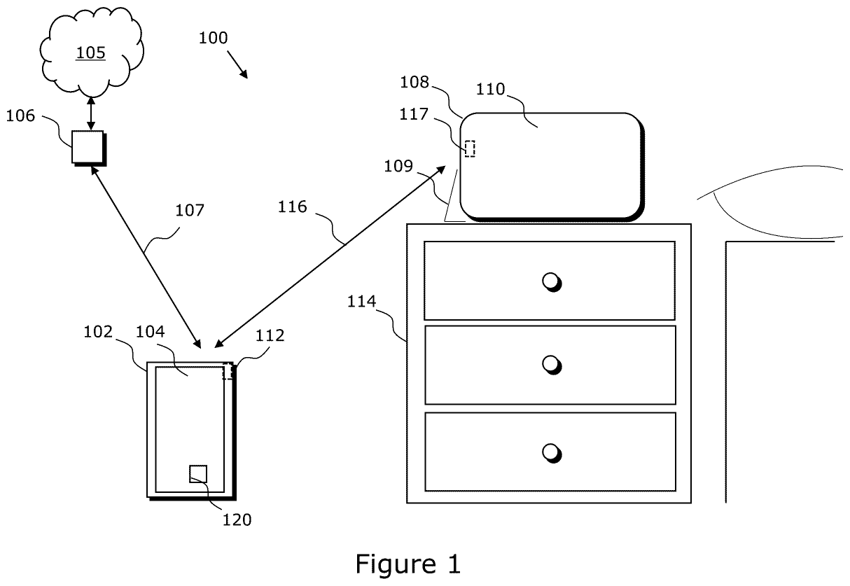

FIG. 1 shows a system 100 according to some example embodiments. The system 100 may comprise a user terminal 102 and a notification device 108.

The user terminal 102 may comprise a mobile telephone 102 or any other form of user terminal which is capable of receiving calls, for example voice calls.

The user terminal 102 may be configured to communicate (receive and/or transmit) data (which may include signaling, voice data and/or other data) with a network 105 via a first air interface 107.

The first air interface 107 may be, but is not limited to, a cellular air interface whereby data is received from/transmitted to a network node 106 of the network 105. The network node 106 may be connected to one or more other network nodes or other systems which may comprise part of the network 105.

The first air interface 107 may conform to a radio access technology (RAT) which the user terminal 102 and network node 106 are configured to support. Examples RATs include Long Term Evolution (LTE) which may be known as fourth generation (4G) or New Radio (NR) which way be known as fifth generation (5G). The network node 106 in the context of 4G may be referred to as an eNB and in the context of 5G may be referred to as a gNB. Example embodiments are not limited to any particular RAT.

The user terminal 102 may comprise a display screen 104 which may or may not be a touch-sensitive display screen.

Other components of the user terminal 102 not shown in FIG. 1 may comprise any of one or more microphones, one or more loudspeakers, one or more cameras, and one or more control buttons.

The user terminal 102 may also comprise one or more antennas 112 for communicating with the network node 106 via the first air interface 107.

The user terminal 102 may also comprise one or more antennas, which may or may not be the same as the above-mentioned one or more antennas 112, for communicating with other devices, such as the notification device 108, via a second air interface 116.

The second air interface 116 may conform to a cellular or non-cellular communication technology which the user terminal 102 and notification device 108 are configured to support. For example, the second air interface 116 may conform to a short-range communication technology such as Bluetooth, WiFi, Zigbee or known variants thereof.

The user terminal 102 may also comprise one or more processors and one or more memories for storing computer-readable instructions that, when executed by the one or more processors, perform operations. The one or more memories may, for example, store an operating system and one or more applications (or “apps”).

The notification device 108 may comprise an apparatus, or hub, which can be located on a substantially flat surface, such as a bedside table 114 as shown. A stand 109 may or may not be provided either as an integral or separate part that supports the notification device 108 in the shown position. The stand 109 may function as a charging device, e.g., a charging docking station, for wired or wireless charging an internal rechargeable battery of the notification device 108 such that the notification device is portable.

The notification device 108 may comprise a front-facing side which carries a display screen 110. The display screen 110 may or may not be a touch-sensitive display screen.

The notification device 108 may also comprise one or more antennas 117 for communicating with other devices, such as the user terminal 102, via the second air interface 116.

As noted above, communications may be by means of Bluetooth, WiFi, Zigbee or known variants thereof.

Other components of the notification device 108 will be described later on.

In some example embodiments, the user terminal 102 may be configured to receive incoming calls and messages and to enable selection of one or more contacts from a contact list to provide a list of one or more preferential contacts.

In some example embodiments, a call destined for the user terminal 102 and originating from a preferential contact may be signaled to the notification device 108. On the other hand, calls originating from non-preferential contacts may not be signaled to the notification device 108. In other words, the user terminal 102 refrains from signaling the call from a non-preferential contact to the notification device 108.

In this way, the user is able to leave the user terminal 102 somewhere other than the room where they sleep, knowing that certain preferential contacts will still be able to reach them via the notification device 108.

Calls may be voice calls conference calls.

Example embodiments may focus on voice calls which may originate from any form of other user terminal capable of initiating a voice call.

The user terminal 102 may comprise a Subscriber Identity Module (SIM) which in use identifies the user terminal to the network 105. The SIM may be a real or virtual SIM. The SIM may store, or is associated with, a telephone number associated with the user terminal 102 and therefore a particular user (hereafter “the user”) of the user terminal.

Other users (hereafter “originating users”) may initiate calls to the user terminal 102 by entering said telephone number into their own user terminal.

As an alternative to entering the telephone number, an originating user may store the user's telephone number, among other telephone numbers, as part of a contact list which can be accessed by their user terminal. The originating user may therefore select a name or other identifier of the user from the contact list to initiate the call.

Once initiated, a call request is routed using known methods to the network node 106 which may be a serving node of the user terminal 102. The network node 106 may signal the call request, with the originating user's caller identity (e.g., telephone number) to the user terminal 102 which may responsively provide a call request notification.

The user terminal 102 may, for example, output one or more sounds via its one or more loudspeakers and/or one or more images on the display screen 104 to alert the user of the call request.

For example, the one or more images on the display screen 104 may comprise the originating user's caller identity, such as their name and/or telephone number.

The user terminal 102 may also provide respective options for selecting to accept or reject the call request.

If accepted, the user terminal 102 may signal its acceptance of the call request to the network node 106 which then, by known methods, enables a voice channel to be established over the air interface 107.

If rejected, the user terminal 102 may signal its rejection of the call request which may then be signaled back to the originating user and no voice channel is established over the air interface 107.

The user terminal 102 may provide a contact list by means of which the user can store details of one or more contacts; for example “a contact” may refer to a name (or other label) linked or otherwise associated with that contact's telephone number.

Other details such as one or more of an address, company name, email address etc., may be provided.

The contact list may be provided as part of an operating system of the user terminal 102 or as a dedicated app associated with a calling function of the user terminal.

The user may initiate a call to a particular contact by means of selecting the particular contact from the contact list, e.g., via the display screen 104, or via some other means, such as through a voice command.

On the other hand, the user may be informed that a particular contact has initiated a call to the user terminal 102 by means of the calling application matching the originating user's caller identity to that of the contact's details in the contact list.

According to some example embodiments, the user terminal 102 may be provided with a dedicated screening app 120 for at least enabling selection of one or more preferential contacts from the contact list.

The screening app is represented schematically in FIG. 1 by an icon 120.

The screening app 120 may be downloaded from a remote server, e.g., an app store, or other service or location.

In some example embodiments, the screening app 120 may comprise a linking (or pairing) function which establishes link or paired relationship between the user terminal 104 and the notification device 108.

For example, the notification device 108 may be provided with an identifier, e.g., a barcode or quick response (QR) code, which can be entered or scanned via the linking or pairing function, following which a link or paired relationship is formed. For example, where the second air interface 116 uses Bluetooth, known Bluetooth pairing methods may be used, whether by use of the barcode or QR code, or some other known method that may not require the function of the screening app 120. Once linked or paired, the user terminal 102 and the notification device 108 can communicate over the second air interface 116.

In some embodiments, the screening app 120 may comprise a function which synchronizes or otherwise obtains at least some of the contacts in the contact list and allows user selection of one or more said contacts of the contact list to be preferential contacts.

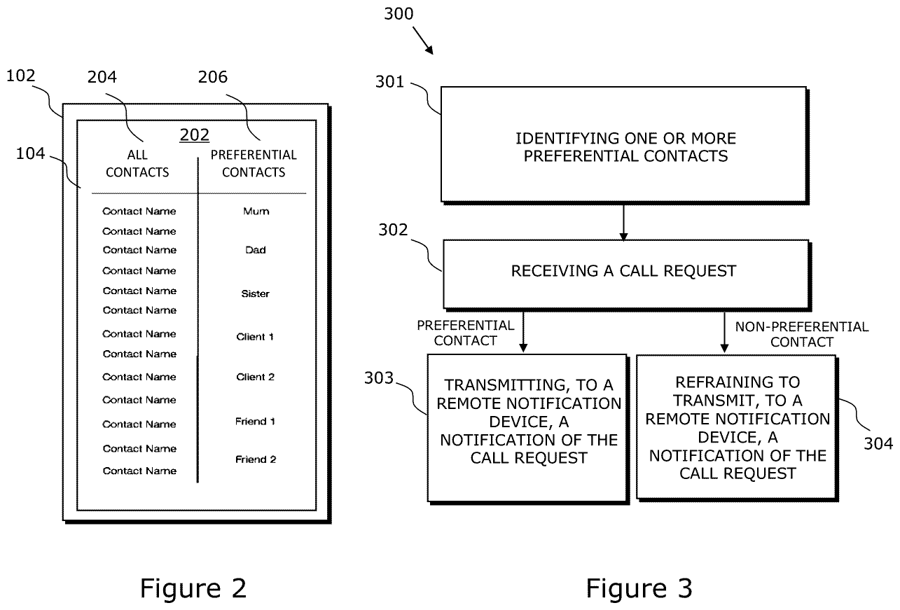

FIG. 2 shows the user terminal 102 when displaying, via the display screen 104, a first user interface 202 of the screening app 120.

The first user interface 202 may show in a first portion 204 at least some of the contacts of the contact list.

Where only a sub-portion of the contact list can be shown, the user may scroll down or up to reveal additional contacts. The user may select particular contacts to be preferential contacts which are then displayed in a second portion 206 of the first user interface 202.

Selection may be by means of a gesture, e.g., by the user placing a finger on or over the particular contact and making a rightwards swipe motion.

Alternatively, selection may be by means of a tap on or over the particular contact.

Alternatively, selection may be by means of a received voice command that the screening app is configured to interpret using known voice recognition methods.

In some example embodiments, selection may alternatively or additionally be automatic, for example based on a label or property associated with the one or more preferential contacts.

For example, contacts whose details are labelled as emergency contacts and/or which identify them as close family (e.g., mum or dad) may be automatically selected.

For example, contacts that have made and/or received more than a threshold number of calls (e.g., more than three calls) with the user terminal 102 within a predetermined time period (e.g., a recent time period, such as within the past two days) may be automatically selected. Said values may be configured by the user via the screening app in some examples.

In some example embodiments, the user may also deselect preferential contacts, e.g., by a reverse swipe, touch input, voice command and/or if a preferential contact has not made and/or received more than a threshold number of calls with the user terminal 102 with a predetermined time period. Regarding the latter, the threshold number of calls and/or predetermined time period may be the same or different than those used to select preferential contacts. For example, a selected preferential contact may be deselected if they have made and/or received less than two calls within the past five days).

Additionally and/or alternatively, the selection and/or deselection may be performed by means of one or more messages received from the notification device 110. That is, the screening app 120 may cause or enable the user terminal 102 to transmit data representing at least part of the first user interface 202 to the notification device 110. The notification device 110 may responsively display at least part of the first user interface 202 and allow selections using any of the above methods. Selections may then be transmitted from the notification device 110 back to the user terminal 120 which stores them for use by the screening app 120.

In some example embodiments, the screening app 120 may screen incoming calls on the basis of the current preferential contacts.

FIG. 3 is a flow diagram showing operations 300 that may be performed according to some example embodiments. The operations 300 may be performed by hardware, software, firmware or a combination thereof. The operations 300 may be performed by one, or respective, means, a means being any suitable means such as one or more processors or controllers in combination with computer-readable instructions provided on one or more memories. The operations 300 may, for example, be performed by the user terminal 102.

A first operation 301 may comprise identifying one or more preferential contacts.

A second operation 302 may comprise receiving a call request. The call request may come from a network.

A third operation 303 may comprise, if the call request is associated with a preferential contact, transmitting, to a notification device which is linked to the user terminal, a notification of the call request.

A fourth operation 304 may comprise, if the call request is from a telephone number or contact which is other than a preferential contact, refraining to transmit to the notification device a notification of the call request.

In the context of the above, transmitting (and receiving) may be by wireless communications.

In some example embodiments, identifying the one or more preferential contacts may comprise enabling selection of the one or more preferential contacts from a contact list. The contact list may be a contact list associated with a calling application of the user terminal 102. The user terminal may be configured to access the predetermined contact list, display on a display device the first user interface 202 showing at least some of the one or more contacts of the predetermined contact list, and receive selection of the one or more preferential contacts 206 by means of one or more user inputs made via the display device.

In some example embodiments, the display device is a display screen 104 of the user terminal 102.

In some example embodiments, the display device is the display screen 110 of the notification device 108. The selection may be received by means of one or more data messages received from the notification device 108.

In some example embodiments, the identification of at least some of the one or more preferential contacts may be performed automatically based on a label or property already associated with the one or more preferential contacts. For example, the label or property may indicate that: the contact is an emergency contact, and/or the contact has made and/or received more than a threshold number of calls with the user terminal within a predetermined recent time period and/or that the contact is running a particular app and/or service from which calls can be received, e.g., by the user terminal.

In some example embodiments, another operation may comprise refraining to transmit to the notification device 108 other notifications associated with non-call applications which are being run on the user terminal. For example, calls (e.g., voice calls) from preferential contacts may be notified to the notification device but text messages from any contact or telephone number may not be notified.

In some example embodiments, another operation may comprise receiving from the notification device 108 a call acceptance signal indicating that a user accepts a call request from a preferential contact. Another operation may comprise, responsive to receiving the call acceptance signal, accepting the call request to the network, e.g., the network node 106 or the network 105. Another operation may comprise, subsequent to the call request being accepted, forwarding subsequent voice data received from the network node 106 or network 105 to the notification device 108 and voice data received from the notification device to the network node or the network. In other words, providing relaying functionality between the network 108 and the notification device 108.

In some example embodiments, a dedicated application, e.g., the screening app 120 referred to above, may enable or perform selection of preferential contacts and the transmitting and refraining functions. The dedicated application may comprise computer-readable instructions, that when executed by one or more processors of the user terminal 102, perform at least the operations 300 and related features described above.

In some example embodiments, the dedicated application, e.g., the screening app 120 referred to above, may operate such that at least the transmitting and refraining functions are enabled without the need to enable any do-not-disturb (DND) mode or night-time mode that may be provided by an operating system or calling function of the user terminal.

In some example embodiments, the dedicated application, e.g., the screening app 120 referred to above, may operate such that at least the transmitting and refraining functions are enabled so long as the dedicated application is running on the user terminal 102, whether in the foreground or background. In other words, there is no need to remember to enable and disable a particular mode, as is the case for a DND or night-time mode.

In some embodiments, the dedicated application, e.g., the screening app 120 referred to above, may require that preferential contacts have the same or a related screening app on their respective user terminal(s) through which calls to the user can be made and received.

In some embodiments, this information may be determined through a central server or website that maintains a list of contacts, user terminals and/or telephone numbers which have downloaded the same or related screening app and/or are subscribed to a screening service associated with the screening app 120.

Similarly, the user may initiate calls to said preferential contacts through the screening app. The screening app 120, or related screening app, may for example provide a calling interface whereby calls can be made over a data network, which may be other than the network 105 shown in FIG. 1, for example an internet protocol (IP) network or similar.

In some embodiments, the first user interface 206 shown in FIG. 2 may indicate which of the contacts in the first portion 204 have the same or a related screening app on their respective user terminal(s) and/or which are subscribed to the screening service.

The user may therefore select said contacts as preferential contacts as above, or the screening app 120 may automatically select said contacts as preferential contacts on the basis that said preferential contacts have the same or related screening app. The user may unselect a select preferential contact if they so wish.

In some embodiments, where a particular contact of the contact list does not have the same or related screening app or is not subscribed to the screening service, selection of said particular contact via the first user interface 206 may cause an invite or link to be sent to said particular contact for enabling said particular contact to download the same or related screening app.

In some embodiments, calls made to the user can be made by said preferential contacts using the same or related screening app at their respective user terminal.

Calls from said preferential contacts made via said same or related screening app may be received by the screening app 120 and may be notified to the notification device 108 in the manner above or the notification device may itself run said same or related screening app for receiving the call request.

Calls not made via said same or related screening app and/or which are not received by the screening app 120 at the user terminal 102 may not be notified to the notification device 108. That is, for the avoidance of doubt, calls which are not made via the same or related screening app and which may be made via a calling function or application which is other than the same or related screening app may not be notified to the notification device 108.

This may be in addition, or alternative to, screening by means of the telephone number.

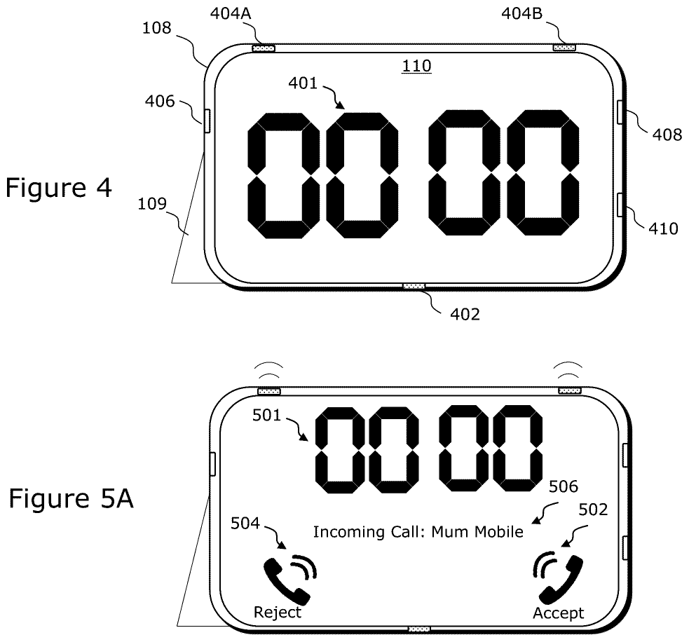

FIG. 4 is a perspective view of the FIG. 1 notification device 108 according to some example embodiments.

In some example embodiments, the notification device 108 may be configured to display, via its display screen 110, an up-to-date clock 401 in any suitable form.

In some example embodiments, the display screen 110 may also display a date or calendar in any suitable form.

In some example embodiments, the notification device 108 may comprise one or more microphones 402 and one or more loudspeakers 404A, 404B.

In some example embodiments, the notification device 108 may comprise one or more of a nightlight button or switch 406, an alarm sleep or snooze button or switch 408 and an emergency services/SOS call button or switch 410.

In some example embodiments, the nightlight button or switch 406 may enable the user to operate a separate light (not shown) or cause the display screen 110 to brighten, at least temporarily, upon selection.

In some example embodiments, the alarm sleep or snooze button or switch 408 may enable the user to disable, at least temporarily, an alert tone of an alarm function; in this regard, the notification device 108 may provide an alarm function for causing at least an alert tone to be emitted by the one or more loudspeakers 404A, 404B at a predetermined time. The predetermined time can be set at the notification device 108 and/or at the user terminal 102.

In some example embodiments, the emergency services/SOS call button or switch 410 may enable the user to initiate, via a single input, a call to a predetermined telephone number (e.g., 999, 911) or a particular contact.

In some example embodiments, the display screen 110 may be configured such as to emit a low level of blue light or no blue light. It is known that, in terms of electromagnetic radiation, the blue light portion of the visible light spectrum (approximately 450 nm or 6.66×10¹⁴ Hz) can raise alertness, suppress the body's release of melatonin (a hormone that induces drowsiness) and affect sleep cycles/circadian rhythms. Therefore, the display screen 110 may be configured to emit all or mainly red, orange and/or yellow light portions of the visible light spectrum. For example, the yellow light portion of the visible light spectrum may be used, having a wavelength range of approximately 580-570 nm or frequency of 5.16-5.25×10¹⁴ Hz.

In some example embodiments, the notification device 108 may be mains powered or battery powered. For example, the notification device 108 may be provided with a charging pad or docking station for wireless, e.g., inductive, charging of a rechargeable battery housed within the notification device 108.

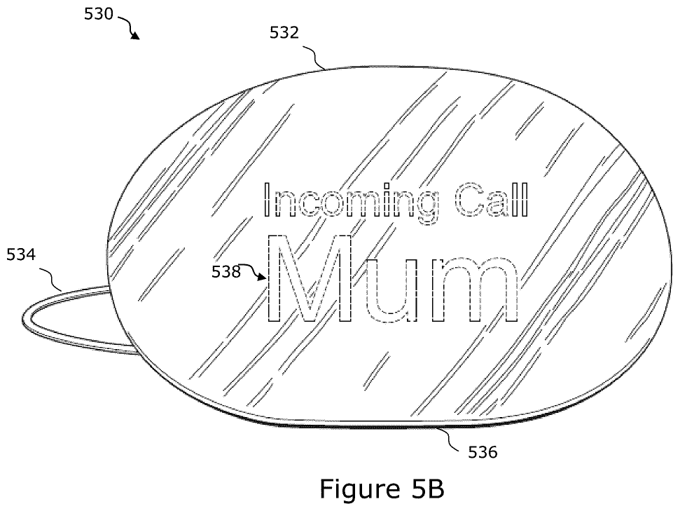

FIG. 5A is a perspective view of the notification device 108 according to some example embodiments upon receipt of a call request notification.

The call request may be received by the user terminal 102, and the user terminal may determine that the call request is associated with a preferential contact of the contact list. Hence, according to one or more earlier described operations, the user terminal 102 may transmit over the second air interface 116, e.g., using Bluetooth or WiFi, the call request notification to the notification device 108 with which it is linked or paired.

The call request notification may be received in the form of one or more data messages which may indicate the preferential contact, e.g., including details such as their name and/or some other label. Other details may include their telephone number and/or an indication as to whether the preferential contact is calling from a mobile or landline number.

In some example embodiments, on receipt of the call request notification, the notification device 108 may be configured to emit audio sound(s) from the one or more loudspeakers 404A, 404B. The audio sound(s) may be emitted at a predetermined volume or may start at a relatively low volume which is increased over time.

In some example embodiments, alternatively or additionally to the above, on receipt of the call request notification the notification device 108 may be configured such that the call request notification, or an alternative representation thereof is displayed, at least in part, by the display screen 110.

In some example embodiments, at least an identity 506 of the preferential contact may be displayed by the display screen 110.

In some example embodiments, the clock 401 may have the same appearance as before, removed from the display screen 110 or shown at a smaller size 501.

In some example embodiments, the display screen 110 may comprise a touch-sensitive display screen, in which case the call request notification may cause respective first and second selectable graphical elements 502, 504 to be displayed.

The respective first and second selectable graphical elements 502, 504 may be responsive to touch inputs, or alternatively swipe inputs, for accepting or rejecting the call request.

In some example embodiments, one graphical element may be displayed, wherein a touch input at a first side, or a swipe input towards the first side of the graphical element may be for accepting the call request, and a touch input at a second side, or a swipe input towards the second side of the graphical element may be for rejecting the call request.

In some example embodiments, the call request may additionally or alternatively be accepted or rejected by means of a voice command.

In some example embodiments, if the user selects to accept the call request, for example by selecting the first graphical element 502, the notification device 108 may be configured to transmit a call acceptance signal to the user terminal 102 over the second air interface 116 for causing the user terminal to accept the call request from the network node 106 or the network 105.

In some example embodiments, subsequent to transmitting the call acceptance signal to the user terminal 106, the notification device 108 may receive voice data over the second air interface 116 which has been forwarded by the user terminal.

In some example embodiments, the notification device 108 may output received voice data using the one or more loudspeakers 404A, 404B.

In some example embodiments, the notification device 108 may capture the user's voice signals using the one or more microphones 402. The notification device 108 may transmit the captured voice signals, as one or more data messages, over the second air interface 116 to the user terminal 106.

In some example embodiments, the user terminal 106 may then forward or relay the received voice data to the network node 106 or the network 105 over the first air interface 107.

In some example embodiments, the notification device 108 may further comprise a means for outputting colored noise, e.g., white, green, brown or pink noise, through the one or more loudspeakers 404A, 404B. For example, such noise may be represented by data stored or accessible to the notification device 108, which can be output upon selection of an appropriate option provided by the notification device. Colored noise is known to help initiate sleep and, in some cases, maintain sleep.

FIG. 5B is a perspective view of another notification device 530 according to some example embodiments.

The notification device 530 may have some or all of the features and functionality of the FIG. 5A notification device 108 and may differ mainly in terms of its appearance. For example, the notification device 530 may comprise a body portion 532 configured to resemble a pebble, stone, rock or similar. The body portion 632 may therefore have a more aesthetically pleasing appearance.

The notification device 530 may also comprise a lead 534 extending from the body portion 532 for connection to a power supply and/or may comprise, within the body portion 532, a rechargeable battery so that the notification device is portable. The rechargeable battery may be charged in any suitable manner, for example by means of occasional connection to mains power, and/or by means of wireless charging. In this context, the notification device 530 may be provided with a stand (as described above) or other form of charging docking station such that when the notification device is suitably located on or adjacent the charging docking station, the rechargeable battery becomes charged.

The body portion 532 may house or contain electronic components disclosed herein, for example a display means, one or more microphones and one or more loudspeakers within a hollowed-out portion of the body portion. The body portion 532 may comprise a substantially flat base portion 536 for being supported by a flat bedside table or similar. The body portion 532 may be weighted to ensure stability when supported on the flat bedside table or similar.

The body portion 532 may comprise, at or on its exterior surface, one or more capacitive touch buttons for implementing input functionality already described with reference to FIGS. 4 and 5A.

A front side of the body portion 532 may be partly transparent, at least in areas adjacent or in front of the display means, in order to display information to the user through the surface of the body portion.

As shown in FIG. 5B, upon receipt of a call request notification from a preferential contact, at least an identity 538 of a preferential contact may be displayed through the front side of the body portion 532.

In other cases, a clock may be displayed as per the FIG. 5A embodiment,

Accepting or rejecting the call request may be by means of any of the options described for the FIG. 5A embodiment, for example by means of touching a capacitive touch button associated with accepting the call request.

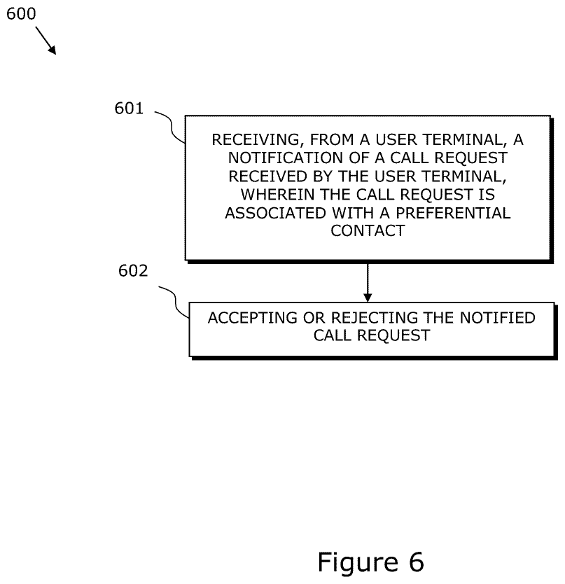

FIG. 6 is a flow diagram showing operations 600 that may be performed according to some example embodiments. The operations 600 may be performed by hardware, software, firmware or a combination thereof. The operations 600 may be performed by one, or respective, means, a means being any suitable means such as one or more processors or controllers in combination with computer-readable instructions provided on one or more memories. The operations 600 may, for example, be performed by the notification device 108.

A first operation 601 may comprise receiving, from a user terminal, a notification of a call request received by the user terminal, wherein the call request is associated with a preferential contact of a contact list.

A second operation 602 may comprise accepting or rejecting the notified call request.

In some example embodiments, one or more other operations may be performed in accordance with the above-described description for FIGS. 4 and 5.

In some example embodiments, the selection of the one or more preferential contacts may be made and/or stored at the notification device 108 instead or, or in addition to, the user terminal 102.

In some example embodiments, all call requests received by the user terminal 102 may be notified to the notification device 108 over the second air interface 116.

Accordingly, it may be the notification device 108 that determines to output the call request notification, if from a preferential contact, and to refrain from outputting the call request notification, if from a non-preferential contact.

In some example embodiments, one or both of the user terminal 102 and the notification device 108 may determine if they are within a predetermined range, i.e., distance, of one another or within a same room.

For example, the user terminal 102 may determine that the notification device 108 is within a predetermined range of the user terminal. The user terminal 102 may for example determine its own position using known multilateration techniques which may use reference signals transmitted to, or received from, fixed receiving and/or transmitting devices with respective known positions. The notification device 108 may determine its own position using the same or similar methods. The two positions may be compared by the user terminal 102 or the notification device 108 to determine the distance between the two, such that it can be determined if the distance is at or above a predetermined threshold, e.g., five metres. If below, one or both of the user terminal 102 and the notification device 108 may issue an alert, which may be an audible and/or visual alert to inform the user that the user terminal should be moved further away from the notification device.

For example, the user terminal 102 may determine that the notification device 108 is within the same room as the user terminal. This may be by means of determining if there is a line-of-sight signal between the user terminal 102 and the notification device 108, e.g., by use of one device emitting an infra-red signal or other optical signal which can be received by the other device where there is a line of sight. Additionally, this may be by means of monitoring a received signal strength of a signal emitted by one device, wherein a below threshold signal strength may be indicative that the two devices are at least separated by a wall. If there is a line-of-sight, or the received signal strength is at or above the threshold signal strength, one or both of the user terminal 102 and the notification device 108 may issue an alert, which may be an audible and/or visual alert to inform the user that the user terminal should be moved further away from the notification device.

Example embodiments may also provide a system, comprising a user terminal 102 of any preceding definition and a notification device 105 according to any preceding definition.

It follows from the above that an apparatus, method, computer program and system are described which may promote good sleep hygiene, encourage or allow users to keep user terminals away from the place where they sleep whilst also allowing call requests from preferential contacts to be notified to a notification device which may be located at the bedside.

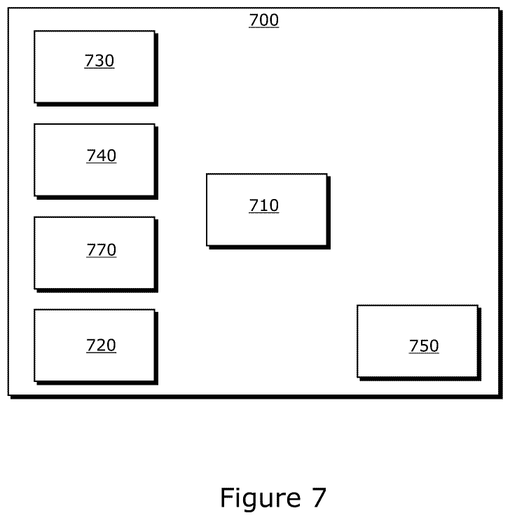

FIG. 7 illustrates an example apparatus 700 capable of supporting at least some embodiments.

The apparatus 700 may comprise components of the user terminal 102 or of the notification device 108.

Comprised in apparatus 700 is a processor 710. The processor 710 may comprise more than one processor. The processor 710 may be means for performing method steps in apparatus 700. The processor 710 may be configured, at least in part by computer instructions, to perform actions.

The apparatus 700 may comprise a memory 720. The memory 720 may comprise random access memory and/or permanent memory. The memory 720 may be at least in part accessible to processor 710. The memory 720 may comprise computer instructions that processor 710 is configured to execute. When computer instructions configured to cause the processor 710 to perform certain actions are stored in the memory 720, and the apparatus 700 overall is configured to run under the direction of the processor 710 using computer instructions from the memory 720, the processor 710 and/or its at least one processing core may be considered to be configured to perform said certain actions.

The apparatus 700 may comprise a transmitter 730 and a receiver 740. The transmitter 730 and the receiver 740 may be configured to transmit and receive, respectively, information in accordance with at least one cellular or non-cellular standard.

The apparatus 700 may comprise a User Interface, UI, 750. The UI 750 may comprise at least one of a display, a keyboard, a touchscreen, a speaker and a microphone. A user may be able to operate the device apparatus via the UI 750, for example to accept incoming telephone calls, to originate telephone calls or video calls.

The apparatus 700 may comprise or be arranged to accept a user identity module 770. The user identity module 770 may comprise, for example, a SIM card installable in device 700. The user identity module 770 may comprise information identifying a subscription of a user of device 700.

The processor 710 may be connected to the other components of the apparatus 700.

Example embodiments may also provide a non-transitory media, for example a computer readable storage medium, e.g., a CD, a DVD, a USB stick, a blue ray disk, etc. The non-transitory media stores computer program instructions, causing an apparatus to perform the method of any preceding process for example as disclosed in relation to the flow diagrams in this specification and related features thereof.

1. A user terminal, comprising:
means for identifying one or more preferential contacts;
means for receiving a call request;
means for transmitting, to a remote notification device which is linked to the user terminal, a notification of the call request if the call request is associated with a preferential contact; and
means for refraining to transmit to the notification device at least a notification of the call request if the call request is associated with a telephone number or contact which is other than a preferential contact.

2. The user terminal of claim 1, wherein:
the one or more preferential contacts are identified by receiving a selection of the one or more preferential contacts from a contact list associated with a calling application of the user terminal, and
the user terminal is configured to access the contact list, display on a display device a first user interface showing at least some of the one or more contacts of the contact list, and receive selection of the one or more preferential contacts by means of one or more user inputs made via the display device.

3. The user terminal of claim 2, wherein the display device is a display screen of the user terminal.

4. The user terminal of claim 2, wherein the display device is a display screen of the notification device, and wherein the selection is received by means of one or more data messages received from the notification device.

5. The user terminal of claim 1, wherein identification of at least some of the one or more preferential contacts is performed automatically based on a label or property associated with the one or more contacts of the contact list.

6. The user terminal of claim 5, wherein the label or property indicates that:
the contact is an emergency contact; and/or
the contact has made and/or received more than a threshold number of calls with the user terminal within a predetermined recent time period.

7. The user terminal of claim 1, further comprising:
means for refraining to transmit to the remote device other notifications associated with non-calling applications which are being run on the user terminal.

8. The user terminal of claim 1, further comprising:
means for receiving from the notification device a call acceptance signal indicating that a user accepts a call request from a preferential contact that has been notified to the notification device;
means for responsively accepting the call request from a network from which the call request was received; and
means for forwarding subsequent voice data received from the network to the notification device and voice data received from the notification device to the network.

9. The user terminal of claim 1, wherein
at least the means for identifying the one or more preferential contacts, and the means for transmitting and refraining to transmit the notification of the call request are provided as part of a dedicated application for being executed on the user terminal and
the dedicated application operates such that said means are enabled without requiring enablement of a do-not-disturb mode or night-time mode provided by the user terminal.

10. The user terminal of claim 1, further comprising:
means for determining that the user terminal is within a predetermined range of the notification device; and
means for responsively signaling to the notification device that the user terminal is within the predetermined range.

11. A notification device, comprising:
means for receiving, from a user terminal which is linked to the notification device, a notification of a call request received by the user terminal, wherein the call request is associated with a preferential contact; and
means for accepting or rejecting the notified call request.

12. The notification device of claim 11, further comprising:
means for, in response to receiving acceptance of the notified call request, transmitting a call acceptance signal to the user terminal for causing the user terminal to accept the call request from a network.

13. The notification device of claim 11, further comprising:
means for receiving voice data which has been forwarded from the network by the user terminal for being output by one or more loudspeakers; and
means for transmitting voice data received by one or more microphones to the user terminal for being forwarded to the network.

14. The notification device of claim 11, wherein the notification device is configured such that the call request notification is made, at least in part, by emitting audio sounds from one or more loudspeakers of the notification device.

15. The notification device of claim 11, further comprising a display screen, wherein the notification device is configured such that the call request notification is displayed by the display screen.

16. The notification device of claim 15, wherein the display screen comprises a touch-sensitive touch screen, and wherein the display screen is configured to display respective first and second selectable graphical elements which are responsive to touch inputs for accepting or rejecting the call request.

17. The notification device of claim 15, wherein the display screen is operated such as to emit low or no blue light during use.

18. The notification device of claim 11, further comprising means for outputting colored noise from one or more loudspeakers of the notification device in response to a user input.

19. The notification device of claim 11, further comprising:
means for determining that the notification device is within a predetermined range of the user terminal; and
means for responsively indicating via a visual and/or audible alert that the user terminal is within the predetermined range of the notification device.

20. A notification device, comprising:
means for providing a list of one or more preferential contacts of a contact list;
means for receiving a call request;
means for outputting a notification of the call request if the call request is associated with a preferential contact; and
means for refraining to output a notification of the call request if the call request is not associated with a preferential contact.
